(19) United States
(12) Patent Application Publication
(10) Pub. No.: US 2005/0195718 A1
(43) Pub. Date: Sep. 8, 2005

(54) Method for controlling rotating speed of disc

(75) Inventors: Hsiang-Yi Fu, Hsinchu (TW); Fu-Hsiang Chen, Hsinchu (TW); Ren-Te Lin, Hsinchu (TW)

Correspondence Address: MADSON & METCALF;GATEWAY TOWER WEST, SUITE 900, 15 WEST SOUTH TEMPLE, SALT LAKE CITY, UT, 84101, US

(73) Assignee: Lite-On it Corp.

(21) Appl. No.: 11/043,592

(22) Filed: Jan. 26, 2005

(30) Foreign Application Priority Data
Mar. 2, 2004 (TW) 093105435

(51) Int. Cl. G11B 5/09

(52) U.S. Cl. 369/53.16; 369/53.3; 369/47.38; 369/47.14

(57) ABSTRACT

A method for controlling a rotating speed of a disc for use in a disc reading apparatus includes the following steps. Firstly, the disc is loaded into the disc reading apparatus. Then, a start-up procedure is executed to discriminate whether to hoist a defect flag. Then, a ready-to-read state is entered to discriminate whether the defect flag is hoisted or not. Afterward, a reading procedure at a substantially constant rotating speed of the disc is executed if the defect flag is hoisted.

### FIELD OF THE INVENTION

The present invention relates to a method for controlling a rotating speed of a disc, and more particularly to a method for controlling a rotating speed of a disc in a disc reading apparatus such as an optical disc drive.

### BACKGROUND OF THE INVENTION

Optical discs such as compact discs (CDs), video compact discs (VCDs) and digital versatile disc (DVDs) are able to be played by recording and reproducing apparatuses. When an optical pickup head of an optical disc drive operates, the light emitted by a light source such as a laser diode is focused by an object lens of the optical pickup head on an optical disc, and the light reflected by the optical disc is transmitted to a light sensor to reproduce information from the disc. Referring to FIG. 1, the optical pickup head 10 moves along two main directions, i.e. a direction perpendicular to the disc plate, referred as a focusing direction F, and a direction parallel to the disc plate, referred as a tracking direction T.

Referring to FIG. 2, a conventional servo control system 1 of an optical disc drive is shown. An optical disc 110 is driven to rotate by a spindle motor 120. For reading data from the rotating disc, the optical pickup head (PUH) is driven to move in a seeking direction by a sled motor 130 or move in a tracking direction by a tracking coil 140. When an electronic signal is generated responsive to an optical signal reflected from the optical disc 110 and received by the optical pickup head 10, the electronic signal is transmitted to a radio frequency (RF) amplifier 150 to be processed into a radio frequency signal RF and a tracking error signal TE. The radio frequency signal RF and the tracking error signal TE are further processed by a digital signal processor (DSP) 170 to generate two control signals TRO and FMO. In response to the control signals FMO and TRO, a motor driver 160 makes adjustments to outputted driving forces for driving the sled motor 130 and the tracking coil 140, thereby properly locating the optical pickup head 10 onto the desired track. For example, the control signal TRO facilitates tracking control of the tracking coil 140 by way of the motor driver 160.

Conventionally, once the digital signal processor 170 detects disorderly waveform of the RF signal frequently, it will be considered that the rotating speed for reading the optical disc is too high for that optical disc. Therefore, the rotating speed is reduced automatically. For example, the rotating speed can be adjusted from the originally speed corresponding to 24× down to 15× or even 10×, whichever is suitable for the read optical disc, until the waveform of the RF signal is restored to normal. The 1× of speed can refer to about 150 k Bytes/s of data transferred per second. And for a higher data transfer rate, a higher rotating speed corresponding to the data transfer rate is needed. The above-mentioned adjustment, however, is not suitable for the case that the disorderly RF signal is caused by defects of optical discs other than improper rotating speed. Referring to FIG. 3, a defective area 30 up to 3 mm in width is exemplified. The defect, for example, may result from scratch or stain. Since no data within this area 30 can be read by the optical pickup head 10, the outputted RF and TE signals would become beyond expectation. For example, the amplitude of the RF signal 40 might be dropped to almost zero for a period of time Td (as shown in FIG. 4). On the other hand, the TE signal becomes fluctuated in the period Td. As known, an ideal tracking error signal is an alternating current (AC) signal distributing in a preset amplitude range without involving any direct current (DC) component. That is, the DC level of the AC signal is preferably zero. The TE signal 50 resulting from the defect of the optical disc, however, fluctuates significantly and has problem in approaching to zero, as shown in FIG. 4. The fluctuation of the TE signal would further result in the unexpected TRO signal and thus improper driving force, which may cause the optical pickup head 10 to over-slide or collide with other parts adjacent thereto. Under this circumstance, it is apparent that the reduction of the rotating speed does not help restoring the RF and TE signals to normal. On the contrary, the reduced rotating speed elongates the period Td so as to make the situation even worse.

### SUMMARY OF THE INVENTION

The present invention provides a method for controlling a rotating speed of a disc, which discriminates whether a defective disc is loaded and makes proper adjustment on rotating speed when the optical pickup head encounters the defective disc.

In accordance with a first aspect, there is provided a method for controlling a rotating speed of a disc for use in a disc reading apparatus. Firstly, the disc is loaded into the disc reading apparatus. Then, a start-up procedure is executed to discriminate whether to hoist a defect flag. Then, a ready-to-read state is entered to discriminate whether the defect flag is hoisted or not. Afterward, a reading procedure at a substantially constant rotating speed of the disc is executed if the defect flag is hoisted.

In an embodiment, the disc is rotated by a spindle motor of the disc reading apparatus, and the substantially constant rotating speed is lower than the maximum rotating speed of the spindle motor.

In an embodiment, the substantially constant rotating speed is equal to or greater than an average of the maximum rotating speed and the minimum rotating speed of the spindle motor.

In an embodiment, the start-up procedure is executed at the minimum rotating speed of the spindle motor.

In an embodiment, the start-up procedure comprises steps of identifying the type of the disc, calibrating the voltage level of a radio frequency signal generated in response to an optical signal reflected from the disc, and hoisting the defect flag when a voltage level of the radio frequency signal has been lower than a threshold value for a predetermined period of time, and reading a table of contents of the disc.

In another embodiment, the start-up procedure comprises steps of identifying the type of the disc, calibrating the voltage level of a radio frequency signal generated in response to an optical signal reflected from the disc, monitoring a tracking error signal generated in response to the optical signal, and hoisting the defect flag when a voltage level of the tracking error signal has been fluctuated to a certain extent within a predetermined period of time, and reading a table of contents of the disc.

In an embodiment, the method further comprises a step of executing the reading procedure at a variable rotating speed of the disc when the radio frequency signal is determined abnormal on the condition that the defect flag is not hoisted.

In an embodiment, the variable rotating speed is performed from high to low until the radio frequency signal restores to normal.

Preferably, the disc and the disc reading apparatus are a digital versatile disc (DVD) and a DVD drive, respectively.

Preferably, the disc and the disc reading apparatus are a compact disc (CD) and a CD drive, respectively.

In accordance with a second aspect, there is provided a method for controlling a rotating speed of a spindle motor of a disc reading apparatus. Firstly, a disc is loaded into the disc reading apparatus. Then, the spindle motor is rotated at a first speed in a start-up procedure. Then, it is discriminated whether a defect flag has been hoisted after entering a ready-to-read state from the start-up procedure. Afterward, the spindle motor is rotated at a constant second speed while executing a reading procedure on a condition that the defect flag has been hoisted, wherein the defect flag is hoisted when the disc reading apparatus detects that a voltage level of a radio frequency signal generated in response to an optical signal reflected from the disc has been lower than a threshold value for a predetermined period of time.

In an embodiment, the method further comprises a step of rotating the spindle motor at a variable rotating speed of the disc when the radio frequency signal is determined abnormal while executing the reading procedure on the condition that the defect flag is not hoisted.

In accordance with a third aspect, there is provided a method for controlling a reading speed of a spindle motor of a disc reading apparatus. Firstly, a disc is loaded into the disc reading apparatus. Then, the spindle motor is rotated at a first speed in a start-up procedure. Then, it is discriminated whether a defect flag has been hoisted after entering a ready-to-read state from the start-up procedure. Afterward, the spindle motor is rotated at a constant second speed while executing a reading procedure on a condition that the defect flag has been hoisted, wherein the defect flag is hoisted when the disc reading apparatus detects that a voltage level of a tracking error signal generated in response to an optical signal reflected from the disc has been fluctuated to a certain extent within a predetermined period of time.

The contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating a typical optical pickup head in a disc drive;

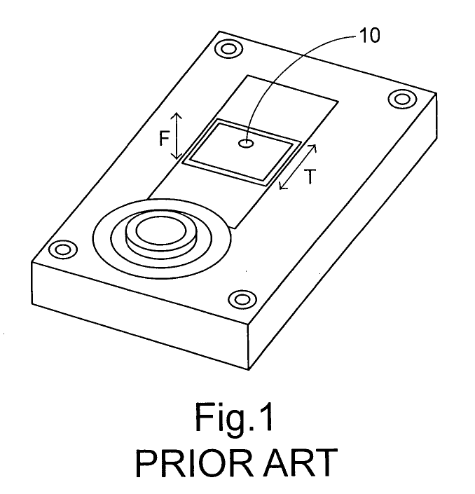

FIG. 2 is a functional block diagram illustrating a conventional servo control system of a disc drive;

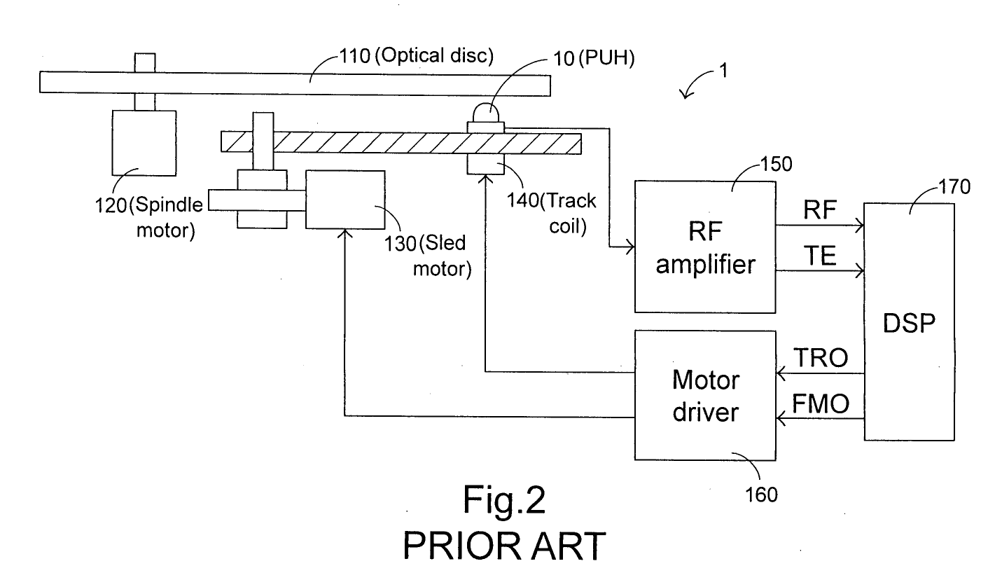

FIG. 3 is a schematic diagram illustrating a defective area of an optical disc;

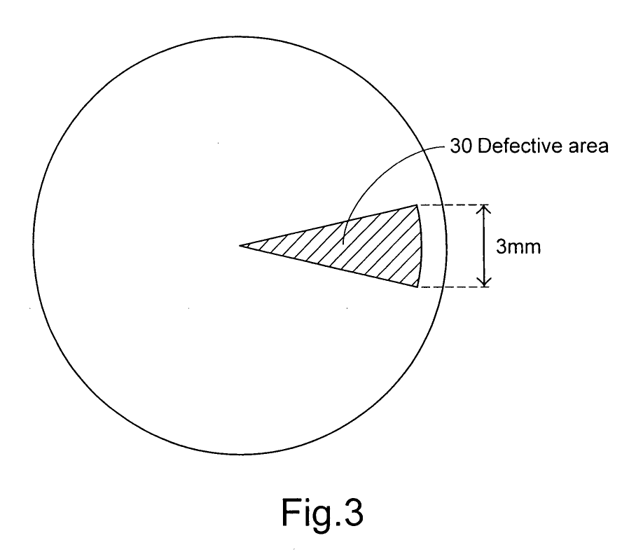

FIG. 4 is a waveform diagram illustrating the resulting radio frequency signal RF and tracking error signal TE generated in the presence of a significant defective area;

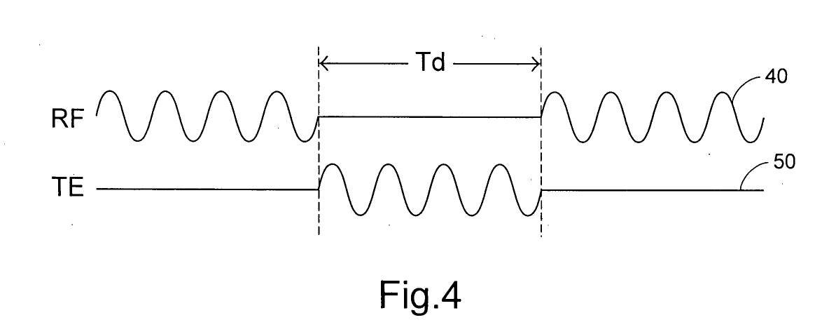

FIG. 5 is a flowchart illustrating a process for controlling a rotating speed of a disc in an optical disc drive according to a preferred embodiment of the present invention; and

FIG. 6 schematically illustrating the hoisting of a defect flag to indicate the presence of a significant defective area in the disc to be read.

### DETAILED DESCRIPTION OF THE PREFERRED EMBODIMENT

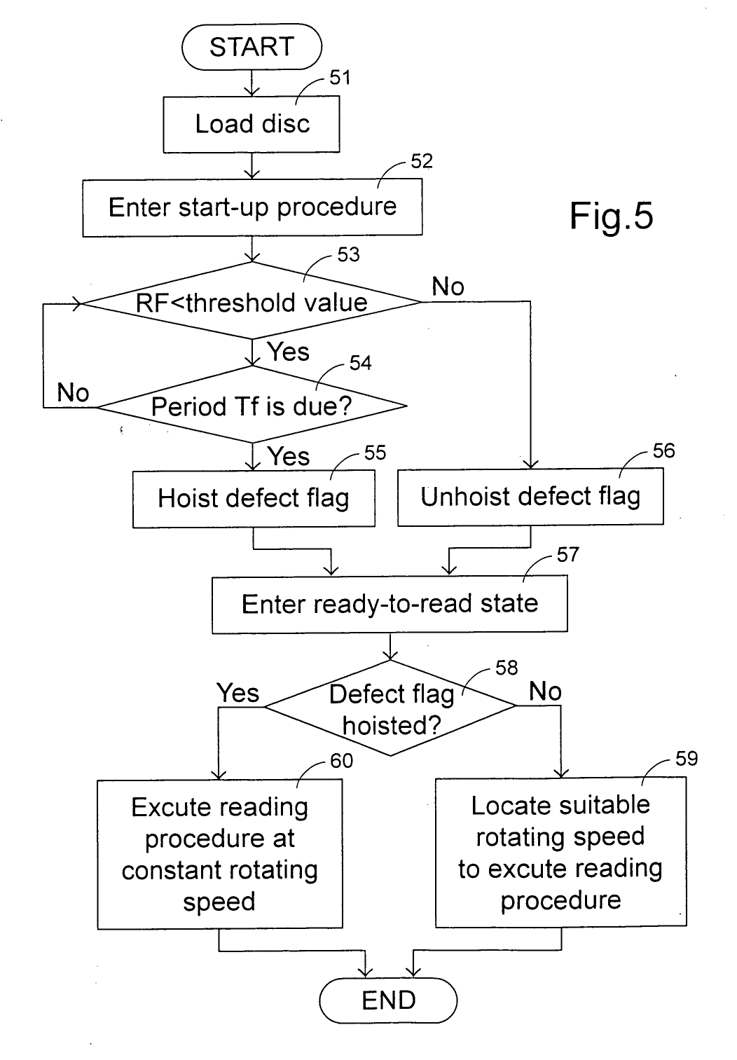

In order to illustrate the process for controlling a rotating speed of a disc in a disc reading apparatus in more details, a flowchart according to a preferred embodiment of the present invention is shown in FIG. 5.

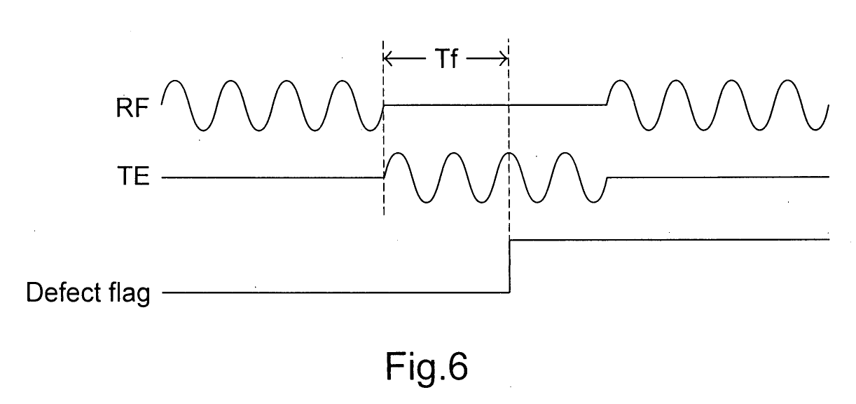

After an optical disc is loaded into the optical disc drive (Step 51), a start-up procedure is entered (Step 52). In the start-up procedure, the spindle motor rotates at the minimum rotating speed, e.g. 10×, to rotate the disc at a slow constant rotating speed. Meanwhile, the type of the disc is firstly identified, the voltage level of a radio frequency signal RF generated in response to an optical signal reflected from the disc 110 is calibrated, and a table of contents (TOC) of the disc is read. In addition, along with the calibration of the voltage level of the radio frequency signal RF, it is discriminated whether to hoist a defect flag of the digital signal processor (DSP) 170 by detecting whether the voltage level of the radio frequency signal RF has been kept lower than a preset threshold value (Step 53) for at least a period of time Tf (Step 54). It is understood that the continuously low-level radio frequency signal RF means an abnormal state of the radio frequency signal RF, as shown in FIG. 6. Accordingly, once the amplitude of the RF signal 40 has been lower than the preset threshold value for the predetermined period of time Tf, the defect flag is hoisted (Step 55) to indicate that the disc has a significant defective area. On the contrary, the defect flag is kept unhoisted to indicate that no defection issue is concerned.

After the start-up procedure, a ready-to-read state is entered (Step. 57), and the information stored on the disc is accessible. While executing a reading procedure, whether the defect flag has been hoisted is detected (Step 58). If the defect flag is not hoisted, it is considered that the disc has no significant defective area thereon. Under this circumstance, if the RF signal is still determined abnormal while executing the reading procedure, the disorderly RF signal may be caused by factors other than the defection of the disc, e.g. improper rotating speed. Therefore, the rotating speed of the spindle motor is changed from high to low gradually until a suitable rotating speed is achieved, i.e. until the RF signal restores to normal (Step 59). On the contrary, if the deflect flag is in a hoisted state, the rotating speed of the spindle motor will be kept at a certain level in order to execute the reading procedure at a high constant rotating speed of the disc (Step 60).

As previously described, the reduced rotating speed fails to help restoring the RF signal to normal on the condition of disc defection. Further, the reduced rotating speed lengthens the period of time encountering with the defective area so as to possibly make the situation even worse. Therefore, according to the present invention, the reading procedure in the disc-defection case is executed at a high constant rotating speed of the disc 110 instead of gradually reduced rotating speed. The high constant rotating speed is preferably lower than the maximum rotating speed of the spindle motor but equal to or greater than an average of the maximum and minimum rotating speeds of the spindle motor. For example, if the maximum and average rotating speeds are corresponding to 24× and 16×, respectively, the reading procedure is preferably executed at a constant rotating speed higher than the speed corresponding to 16× but lower than 24×. For example, the rotating speed is set corresponding to 20×.

Besides the radio frequency signal RF, the tracking error signal TE can also be referred to discriminate whether to hoist the defect flag. During the start-up procedure, if the amplitude of the tracking error signal TE has been fluctuated to a certain extent within a predetermined period of time, e.g. the period Tf as shown in FIG. 6, it can be deferred that the disc has a significant defective area so that the above rotating speed control is performed.

In the above embodiments, the disc and the disc reading apparatus are exemplified as a digital versatile disc (DVD) and a DVD drive, respectively. Alternatively, the disc and the disc reading apparatus can also be a compact disc (CD) and a CD drive, respectively, or any other equivalent means. It is understood from the above description that the method of the present invention is effective to solve the signal deviation problem resulting from disc defection by properly adjusting the rotating speed of the disc. Accordingly, the over-slide or collision probability of the optical pickup head due to improper actuating force can be effectively minimized.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A method for controlling a rotating speed of a disc for use in a disc reading apparatus, comprising steps of:
loading the disc into the disc reading apparatus;
executing a start-up procedure and discriminating whether to hoist a defect flag;
entering a ready-to-read state and discriminating whether the defect flag is hoisted or not; and
executing a reading procedure at a substantially constant rotating speed of the disc if the defect flag is hoisted.

2. The method according to claim 1 wherein the disc is rotated by a spindle motor of the disc reading apparatus and the substantially constant rotating speed is lower than the maximum rotating speed of the spindle motor.

3. The method according to claim 2 wherein the substantially constant rotating speed is equal to or greater than an average of the maximum rotating speed and the minimum rotating speed of the spindle motor.

4. The method according to claim 3 wherein the start-up procedure is executed at the minimum rotating speed of the spindle motor.

5. The method according to claim 1 wherein the start-up procedure comprises steps of:
identifying the type of the disc;
calibrating the voltage level of a radio frequency signal generated in response to an optical signal reflected from the disc, and hoisting the defect flag when a voltage level of the radio frequency signal has been lower than a threshold value for a predetermined period of time; and
reading a table of contents of the disc.

6. The method according to claim 1 wherein the start-up procedure comprises steps of:
identifying the type of the disc;
calibrating the voltage level of a radio frequency signal generated in response to an optical signal reflected from the disc;
monitoring a tracking error signal generated in response to the optical signal, and hoisting the defect flag when a voltage level of the tracking error signal has been fluctuated to a certain extent within a predetermined period of time; and
reading a table of contents of the disc.

7. The method according to claim 1 further comprising a step of executing the reading procedure at a variable rotating speed of the disc when the radio frequency signal is determined abnormal on the condition that the defect flag is not hoisted.

8. The method according to claim 7 wherein the variable rotating speed is performed from high to low until the radio frequency signal restores to normal.

9. The method according to claim 1 wherein the disc and the disc reading apparatus are a digital versatile disc (DVD) and a DVD drive, respectively.

10. The method according to claim 1 wherein the disc and the disc reading apparatus are a compact disc (CD) and a CD drive, respectively.

11. A method for controlling a rotating speed of a spindle motor of a disc reading apparatus, comprising steps of:
loading a disc into the disc reading apparatus;
rotating the spindle motor at a first speed in a start-up procedure;
discriminating whether a defect flag has been hoisted after entering a ready-to-read state from the start-up procedure; and
rotating the spindle motor at a constant second speed while executing a reading procedure on a condition that the defect flag has been hoisted, wherein the defect flag is hoisted when the disc reading apparatus detects that a voltage level of a radio frequency signal generated in response to an optical signal reflected from the disc has been lower than a threshold value for a predetermined period of time.

12. The method according to claim 11 wherein the first speed is the minimum rotating speed of the spindle motor.

13. The method according to claim 11 wherein the second speed is lower than the maximum rotating speed of the spindle motor, and equal to or greater than an average of the maximum rotating speed and the minimum rotating speed of the spindle motor.

14. The method according to claim 11 further comprising a step of rotating the spindle motor at a variable rotating speed of the disc when the radio frequency signal is determined abnormal while executing the reading procedure on the condition that the defect flag is not hoisted.

15. The method according to claim 14 wherein the variable rotating speed is performed from high to low until the radio frequency signal restores to normal.

16. A method for controlling a reading speed of a spindle motor of a disc reading apparatus, comprising steps of:
loading a disc into the disc reading apparatus;
rotating the spindle motor at a first speed in a start-up procedure;
discriminating whether a defect flag has been hoisted after entering a ready-to-read state from the start-up procedure; and
rotating the spindle motor at a constant second speed while executing a reading procedure on a condition that the defect flag has been hoisted, wherein the defect flag is hoisted when the disc reading apparatus detects that a voltage level of a tracking error signal generated in response to an optical signal reflected from the disc has been fluctuated to a certain extent within a predetermined period of time.

17. The method according to claim 16 wherein the first speed is the minimum rotating speed of the spindle motor.

18. The method according to claim 16 wherein the second speed is lower than the maximum rotating speed of the spindle motor, and equal to or greater than an average of the maximum rotating speed and the minimum rotating speed of the spindle motor.

19. The method according to claim 16 further comprising a step of rotating the spindle motor at a variable rotating speed of the disc when a radio frequency signal generated in response to the optical signal is determined abnormal while executing the reading procedure on the condition that the defect flag is not hoisted.

20. The method according to claim 19 wherein the variable rotating speed is performed from high to low until the radio frequency signal restores to normal.
